(19) United States
(12) Patent Application Publication
(10) Pub. No.: US 2015/0239297 A1
(43) Pub. Date: Aug. 27, 2015

(54) ANTI-RESONANCE NOISE DEVICE FOR TIRE

(71) Applicants: COMPAGNIE GENERALE DES ETABLISSEMENTS MICHELIN, Clermont-ferrand (FR); MICHELIN RECHERCHE ET TECHNIQUE S.A., Granges-paccot (CH)

(72) Inventors: Frederic Bourgeois, Clermont-Ferrand (FR); Francois-Xavier Bruneau, Clermont-Ferrand (FR); Pascal Fickinger, Clermont-Ferrand (FR)

(21) Appl. No.: 14/431,051

(22) PCT Filed: Sep. 25, 2013
(86) PCT No.: PCT/EP2013/069910

§ 371 Date: Mar. 25, 2015

(30) Foreign Application Priority Data
Sep. 26, 2012 (FR) 1259031

(51) Int. Cl. B60C 11/13; B60C 19/00

(52) U.S. Cl. CPC B60C 11/1307; B60C 19/002; B60C 2011/1338

(57) ABSTRACT

Tire tread, comprising at least one groove of width W and depth P which is delimited by two walls facing one another, these walls being joined together by a groove bottom, at least one groove comprising at least one flexible device for at least partially closing this groove as it enters the contact patch in which the tire is in contact with a roadway, each flexible device comprising at least one blade of a thickness suited to allowing it to flex under the effect of a circulation of liquid, this at least one blade being borne by a wall delimiting the groove, each blade of thickness E being bounded by a bottom wall facing the bottom of the groove, an end wall facing the other wall of the groove and a contact wall intended to come into contact with the roadway and lateral walls spaced apart from one another by a distance equal to the thickness E of the blade, this tread being such that the bottom wall of the blade comprises a first part extending between the points of connection with the wall bearing the blade, a second part extending the first part, this second part being extended by a third part as far as the end part of the blade, the first part and the second part being offset towards the outside with respect to a plane connecting the points of connection with the wall bearing the blade and the points of connection of the second part to the third part in order to form a notch of maximum height H in the bottom wall of the blade, this tread being characterized in that the angle between the second part and the third part is greater than 110 degrees and less than 180 degrees.

This application is a 371 national phase entry of PCT/EP2013/069910, filed 25 Sep. 2013, which claims benefit of French Patent Application No. 1259031, filed 26 Sep. 2012, which is incorporated herein by reference for all purposes.

### BACKGROUND

1. Field

The present disclosure relates to tire treads and more particularly to treads comprising grooves comprising flexible devices for reducing the noise generated by air going into resonance inside these grooves during driving.

2. Description of Related Art

It is known that as a tire that is running comes into contact with a roadway in the contact patch, air is made to circulate in a pipe formed by a groove, notably by a groove of circumferential overall orientation and the roadway itself, this pipe being open at both of its ends.

The air in this pipe forms a vibrating column of air the resonant frequency of which is dependent on the length between the two ends of the pipe and, therefore, on the length of groove in contact with the roadway.

This resonance of the air in the grooves has the result of generating, in a vehicle fitted with these tires, a noise inside the vehicle and a noise outside the vehicle.

These inside and outside noises usually correspond to a frequency of 1 kHz or there about, which is a frequency to which the human ear is particularly sensitive. In order to reduce such resonance noise, it is known practice to arrange, in each circumferentially oriented or generally circumferentially oriented groove, a plurality of relatively thin closure blades or membranes made of a rubber composition, each closure blade or membrane occupying the entire cross section of the groove or, at least, a large proportion of this cross section. Each closure membrane may extend from the bottom of the groove or may be fixed to at least one of the walls delimiting the said groove. Relatively thin means that each closure membrane is able to flex in order to open the cross section of the groove under the effect of a flow of liquid notably when driving in the wet.

Thanks to these closure membranes, the length of the column of air in each circumferential groove is reduced by comparison with the total length of the groove in the contact patch and this leads to a change in the resonant frequency. The shift in frequency is towards resonant frequencies to which the human ear is less sensitive.

Of course, in order to maintain the water-drainage function, when driving on a roadway covered with water, it is necessary for this membrane to be able to flex appropriately under the action of the pressure of the water and thus open the cross section of the groove. Several solutions of this type for reducing the resonance of the column of air vibrating in the grooves have been proposed.

One approach is, for example, described in patent documents FR 2715891, JP 3-276802, JP 08-150812, JP 4-221207.

While these devices are effective in the new state, it has been found that these closure devices were not necessary any longer after partial wear exceeding around 50% of the thickness of the tread. Therefore, in an application as yet unpublished at the time of filing of the present application, there has been proposed a solution that seeks to allow the closure device to be eliminated after a predetermined wear level has been exceeded. In that proposal, each membrane of the device is fixed to a lateral wall delimiting a groove and a notch is formed on the bottom wall of the membrane in the vicinity of the wall bearing the said membrane. FIG. 1 shows such an embodiment of the prior art. This arrangement also makes the molding operation easier.

However, it was found with this last type of membrane that incidents could occur during the demolding step: what happened was that bits of membrane could become torn, thereby correspondingly reducing the closing of the groove and the effectiveness of the device at reducing the noise.

Definitions:

The tread surface of a tread corresponds to the surface of the tread that comes into contact with the ground when a tire provided with such a tread is being driven on. The tread surface in the new state corresponds to the surface of the tread directly in contact with the surface of the mound that molds this tread.

A groove corresponds to a space formed in a tread, this space being delimited by walls of material, these walls being joined together by a groove bottom distant from the tread surface of the tread by a distance equal to the depth of the groove. The groove bottom corresponds to that part of the groove that is situated radially below the tread wear indicator that indicates the limit beyond which the tread no longer meets the legal requirements for use.

A block is a raised element formed on a tread, this element being delimited by voids or grooves and comprising lateral walls and a contact face, the latter—intended to come into contact with the roadway during driving—forming part of the tread surface of the tread.

A rib is a raised element formed on a tread, this element being delimited by two grooves. A rib comprises two lateral walls and a contact face, the latter being intended to come into contact with the roadway.

A radial direction means a direction perpendicular to the axis of rotation of the tire (this direction corresponds to the direction of the thickness of the tread).

An axial direction means a direction parallel to the axis of rotation of the tire.

A circumferential direction means a direction which is tangential to any circle centered on the axis of rotation. This direction is perpendicular both to the axial direction and to a radial direction.

### SUMMARY

The present invention, in an embodiment seeks to obtain a groove closure device that is easier to mound and demold by comparison with the known devices formed of blades secured to one of the walls delimiting a groove, the present invention very significantly reducing faults during demolding. Implementation of this device may concern any type of groove, whether this groove be oriented circumferentially, transversely or obliquely.

To this end, one subject of the invention is a tire tread, this tread having a tread surface intended to come into contact with a roadway and comprising at least one groove of width W and depth P which is delimited by two walls facing one another, these walls being joined together by a groove bottom, at least one groove comprising at least one flexible device for at least partially closing this groove as it enters the contact patch in which the tire is in contact with a roadway, each flexible device comprising at least one blade of a thickness suited to allowing it to flex under the effect of a circulation of liquid, this at least one blade being borne by a wall delimiting the groove, each blade of thickness E and width L being bounded by a bottom wall facing the bottom of the groove, an end wall facing the other wall of the groove and a contact wall intended to come into contact with the roadway and lateral walls spaced apart from one another by a distance equal to the thickness E of the blade.

This tread being such that the bottom wall of the blade comprises a first part extending between the points of connection with the wall bearing the blade, a second part extending the first part, this second part being extended by a third part as far as the end part of the blade, the first part and the second part being offset towards the outside with respect to a plane connecting the points of connection with the wall bearing the blade and the points of connection of the second part to the third part in order to form a notch of maximum height H in the bottom wall of the blade.

This tread is characterized in that the angle between the second part and the third part is greater than 110 degrees and less than 180 degrees.

Advantageously, the angle between the second part and the third part is at least equal to 130 degrees and at most equal to 160 degrees.

Consider, in a plane of cross section, the straight line—referred to as the reference straight line—connecting the point of connection between the profile of the first part and the profile of the second part of the bottom wall in the same plane of section and the start of the profile of the third part in the same plane of section. The invention recommends that the profile of the second part should remain close to this reference straight line, or should even coincide with this straight line.

The height H of the notch is measured in the direction of the depth of the groove between this reference straight line and those points of the first part that are closest to the tread surface in the new state. The width T of the notch is measured in the direction of the width of the groove.

In the context of the invention, the expression “wall bearing the blade” must be interpreted here as meaning one of the lateral walls delimiting the groove.

By virtue of the an embodiment of the invention, it is possible to avoid concentrations of load on the connection between the parts forming the notch and the rest of the bottom wall of the blades.

Advantageously, the first part and second part of the bottom wall extend over a width T at least equal to 30% of the total width L of the blade measured on the bottom part of the said blade.

Advantageously, the tread is such that, in the new state, the depth H of the notch formed by the first and second parts of the bottom wall is less—in the new state—than 15% of the maximum distance R of the points of the third part of the bottom wall as measured with respect to the same tread surface in the new state.

Advantageously, the first part of the bottom wall is formed of a circular arc having a small radius of curvature, namely a radius at least equal to 5% of the width W of the groove and at most 30% of same width W.

According to an advantageous alternative form, the second part extending the first part of the bottom wall is planar or near-planar, i.e. has curvatures that are very slight. A curvature that is very slight here means that the radius of curvature is at least equal to 100 mm.

According to another advantageous alternative form, the distance separating the third part of the bottom wall from the bottom of the groove is at most equal to 10% of the depth of the groove.

Advantageously, the profile of the third part of the bottom wall of the blade is parallel to the profile of the groove bottom.

According to another advantageous alternative form, the profile of the third part may be of reduced length such that the second part connects directly to the end part of the blade. In such instances, the second part connects to the end wall of the blade at an angle of at least 20 degrees and at most 70 degrees.

The invention, in addition to relating to the alternative forms of tread as listed, relates to the tires provided with such treads.

In an advantageous alternative form, a notch is formed between each blade and the wall bearing the said blade in the connecting part situated near the tread surface in the new state. This notch increases the flexibility of each blade. This notch may take the form of an incision of narrow or even zero width.

It is also possible to provide a transverse housing on the bottom of the groove so as to allow the bottom wall of a blade to become at least partially lodged therein in order to increase the extent to which the cross section of the said groove is closed by the said blade.

For preference, the depth of this housing is at least equal to the height of the notch so that the blade closes off as far as possible the groove in which it is formed.

A like housing may also be provided on the wall to which a blade according to the invention is connected. A similar layout applies to the case of a single blade completely closing off the cross section of a groove; in this case, it is advantageous to provide a groove forming a housing for the end part of each blade.

Other features and advantages of the invention will become apparent from the description given hereinafter with reference to the attached drawings which, by way of nonlimiting examples, depict alternative forms of embodiment of the subject matter of the invention.

### BRIEF DESCRIPTION OF THE FIGURES

FIG. 1 shows one alternative form of a device according to the prior art, this device comprising two blades borne by the lateral walls of a groove;

FIG. 2 shows a first alternative form of a device comprising two blades according to the invention;

FIG. 3 shows two alternative forms of blades of a device according to the invention, for which the third part is reduced in width to a line on the end face of the blade;

FIG. 4 shows a view of a single blade almost completely obstructing a groove of a tread according to the invention, this single blade being partially inset into a housing in the lateral walls and in the bottom of the groove.

### DESCRIPTION OF SPECIFIC EMBODIMENTS

In the figures accompanying this description, the same reference signs can be used to describe alternative forms of the invention as long as these reference signs refer to elements of a like nature, whether this nature be structural or indeed functional.

FIG. 1 shows, in cross section, a partial view of a tread according to the prior art, this tread being fitted to a tire of size 225/55 R 17. This figure depicts a groove 1 bounded by two raised elements 2, 3 of the tread, this groove 1 extending substantially in a circumferential direction of the tire on which the said tread is mounted. This groove 1, of width W—measured on the tread surface in the new state—equal to 13 mm and of depth P equal to 7.5 mm, is bounded by a first wall 20 and a second wall 30 that face one another and by a groove bottom 10 connecting these two walls together. The tread comprises a tread surface 100 intended to be in contact with a roadway during driving. In what follows, the bottom wall 10 of the groove 1 corresponds to that part of the groove that remains after the tread has worn down to the legal limit set by the national regulations.

This groove 1 comprises an anti-noise device formed of a plurality of flexible blades molded in the said groove to form a plurality of obstacles. Each device comprises two blades 4, 4′ each one occupying half the cross section of the groove 1, these blades 4, 4′ being in the extension of one another. Each blade 4, 4′ projects from a respective wall 20, 30.

Molded into the first wall 20 is a first blade 4 of a thickness that is small (which in this instance means a thickness equal to 0.6 mm) so that it can easily flex about an axis more or less along the connection between this first blade 4 and the wall 20 to which it is connected with a view to allowing water to flow along the groove 1 when driving over a wet roadway while at the same time forming an obstacle to the circulation of air when driving on a dry roadway.

This first blade 4 is bounded by a bottom wall 40 facing the bottom 10 of the groove, an end wall 41 facing the second wall 30 of the groove 1 and a contact wall 42 which is intended to come into contact with the roadway and lateral walls 43, 44 which are spaced apart by a distance equal to the thickness of the blade.

The bottom wall 40 of the first blade 4 comprises a first part referred to as the connection part 401 connecting with the wall 20 bearing this blade, this connection part 401 having, in a plane of cross section transverse to the main direction of the groove, a semicircular profile, the center of curvature of which is situated on the same side as the bottom 10 of the groove and the radius of curvature of which is, in this instance, equal to 1 mm.

“Located on the same side as the bottom 10 of the groove” is to be understood as meaning that the connection part 401 forms a kind of notch in the blade, the concavity of this notch facing towards the bottom 10 of the groove.

The connection part 401 is extended by a substantially plane additional part 402 as far as the end part 41 of the blade 4.

The junction between the connection part 401 and the additional part 402 occurs—in the cross-sectional view of FIG. 1—at a point of inflection I.

Formed in combination with this first blade 4 is a second blade 4′ of the same geometry, this second blade being connected to the second wall 30 situated facing the first wall 4 so as to obstruct the cross section of the groove almost completely. In the scenario depicted, the first blade 4 and the second blade 4′ are formed in such a way as to have their respective end parts in contact with one another after the tread has been molded.

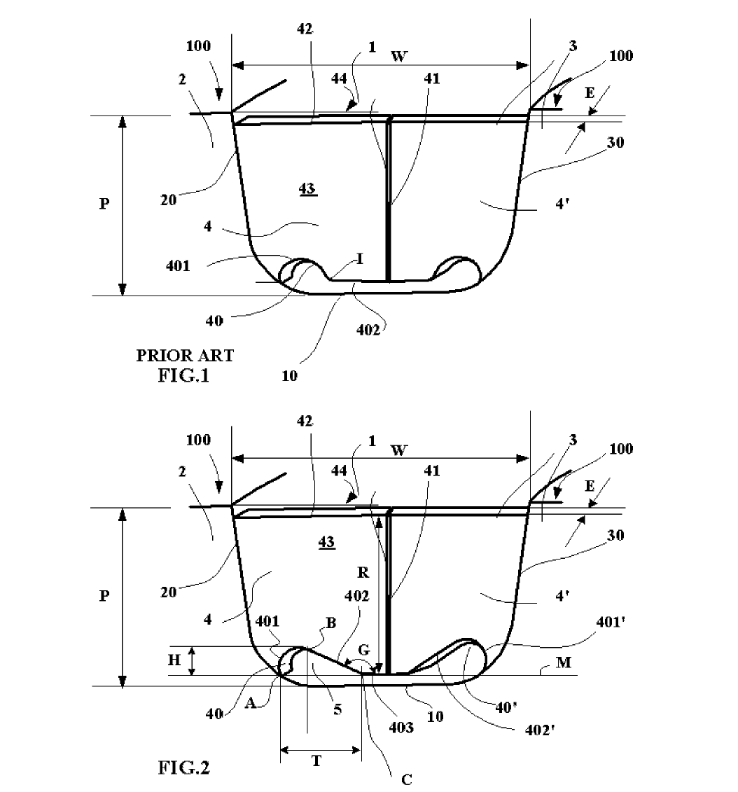

FIG. 2 shows an alternative form of a noise reducing device, this device comprising two blades 4 and 4′ according to the invention. These blades 4 and 4′ are, on the whole, similar to those shown in FIG. 1, except that the bottom part of each blade is constructed according to the invention. The size of the tire is identical to that of the example of the prior art shown in FIG. 1, and the key dimensions are reused again here, particularly the thicknesses of the blades.

The bottom wall 40 of the blade 4 comprises a first part 401 extending between the points of connection with the wall bearing the blade, a second part 402 extending the first part, this second part being extended by a third part 403 as far as the end part 41 of the blade, the first part and the second part being offset towards the outside with respect to a plane, identified by its line M in the plane of the figure, connecting the points of connection A with the wall 20 bearing the blade 4 and the points of connection B of the second part 402 to the third part 403 to form, in the bottom wall of the blade 4, a notch 5 of maximum height H and width T.

The first part 401 is in the shape of a circular arc and is extended by a planar second part connecting tangentially to the first part. This second part 402 is extended by a planar third part 403 parallel to the bottom 10 of the groove 1. The third part 403 is close to the bottom of the groove, namely less than 0.5 mm away. In this particular instance, the depth P of the groove is equal to 7.5 mm and the distance R separating the points of the third part 403 from the top wall 42 of the blade 4 is equal to 6.5 mm, this top wall 42 being offset slightly outwards.

Furthermore, the angle G measured between the second part 402 and the third part 403 is, in this instance, equal to 145 degrees.

The first part 401 and the second part 402 form a notch 5 on the bottom wall 40 of the blade 4. This notch 5 has a depth H here equal to 0.5 mm and a width T measured between the point A of connection to the wall of the groove and the point C of connection to the third part, equal to 2 mm.

The other flexible blade 4′ is constructed to have a geometry identical to that of the blade 4 with which it collaborates to close off the groove (the end walls 41 and 41′ are in contact in the closed position).

This arrangement makes molding and demolding the tire provided with blades that obstruct the grooves easier and reduces the risk of damage in the region of the point C.

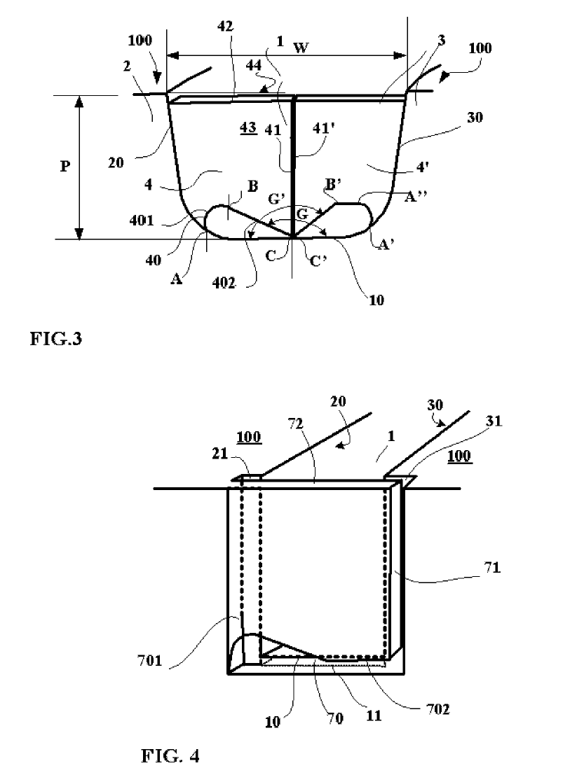

FIG. 3 shows two alternative forms of blades of a device according to the invention for which each third part 403, 403′ is reduced, in terms of width, to a line on the end wall of each blade. This FIG. 3 shows a groove 1 in cross section, this groove comprising a device for reducing resonance noises in driving. This device comprises a first blade 4 and a second blade 4′ both constructed on the principle of the blades shown in FIG. 2.

The groove 1 is delimited by the lateral faces 20, 30 of raised elements 2, 3.

A first blade 4, borne by a lateral wall 20 of an element 2, comprises on its bottom wall 40 a first part 401 extending between the points of connection A with the wall 20 bearing the blade 4, a second part 402 extending the first part 401, this second part 402 being extended as far as the end part 41 of the blade. In this particular instance, the third part is reduced, in the plane of the figure, to a point C. All the points of the first and second parts are arranged in such a way as to form a notch 5 extending over the entire width of the blade 4.

The second blade 4′ facing the blade 4 is borne by the other wall 3 exhibits an alternative form of geometry of the notch 5′ whereby the first part is formed as a circular arc between a point A′ on the wall 30 and a point A″, this circular arc being extended by a straight-line segment between this point A″ and a point B′, this segment running parallel to the bottom 10 of the groove 1. This first part is extended by a planar part (straight in the plane of the figure) as far as a point C′ positioned on the end wall 41′ of the blade 4′.

In these two alternative forms, the angles G and G′ are measured with respect to a direction parallel to the bottom of the groove in the plane of FIG. 3. These angles G and G′ are respectively equal to 155 degrees and to 130 degrees.

FIG. 4 shows a view of a single blade 7 almost entirely obstructing a groove 1 of a tread according to the invention, this single blade 7 being partially inset into a housing 21 formed on a lateral wall 20. This blade 7 comprises an end wall 71 situated on the opposite side to the part connected to the lateral wall 20, a bottom wall 70 and a contact wall 72 intended to come into contact with the roadway during driving. This contact wall 72 is, in the new state, in the extension of the tread surface 100 of the tread.

Formed in the bottom wall 70 is a notch 75 delimited by a first part 701 connected to the wall 20 and a second part 702 in the continuation of the said first part. This second part 702, which meets a third part 703 which runs parallel to the bottom 10 of the groove. The angle between the second part and the third part is greater than 110 degrees.

Furthermore, provided in the continuation of the first housing 21 is a second housing 11 formed on the bottom 10 of the groove. The depths of these first and second housings are suited to ensuring that the entire notch 57 remains hidden by the material so that the blade 7 completely closes off the cross section of the groove 1.

Finally, a third housing 31 is provided in the extension of the second housing on the wall 30 delimiting the groove 1 with the wall 20.

As the invention has been described in general terms and using a number of alternative forms, it should be understood that this invention is not restricted only to these alternative forms described and depicted. The various alternative forms described here can be combined with one another by a person skilled in the art to suit the end objective.

It is also possible to form a closure device comprising two blades according to the invention, these blades being offset from one another in the main direction of the groove in which the said closure device is formed.

1. A tire tread, this tread comprising a tread surface intended to come into contact with a roadway and comprising at least one groove of width W and depth P which is delimited by two walls facing one another, these walls being joined together by a groove bottom, at least one groove comprising at least one flexible device for at least partially closing this groove as it enters the contact patch in which the tyre is in contact with a roadway, each flexible device comprising at least one blade of a thickness suited to allowing it to flex under the effect of a circulation of liquid, this at least one blade being borne by a wall delimiting the groove, each blade of thickness E being bounded by a bottom wall facing the bottom of the groove, an end wall facing the other wall of the groove and a contact wall intended to come into contact with the roadway and lateral walls spaced apart from one another by a distance equal to the thickness E of the blade,
this tread being such that the bottom wall of the blade comprises a first part extending between the points of connection with the wall bearing the blade, a second part extending the first part, this second part being extended by a third part as far as the end part of the blade, the first part and the second part being offset towards the outside with respect to a plane connecting the points of connection with the wall bearing the blade and the points of connection of the second part to the third part in order to form a notch of maximum height H in the bottom wall of the blade, wherein the angle between the second part and the third part is greater than 110 degrees and less than 180 degrees.

2. The tread according to claim 1, wherein the angle between the second part and the third part is at least equal to 130 degrees and at most equal to 160 degrees.

3. The tread according to claim 1, wherein the first part and the second part of the bottom wall extend over a width T at least equal to 30% of the total width L of the blade measured on the bottom wall of the said blade.

4. The tread according to claim 1, wherein the depth H of the notch formed by the first and second parts of the bottom wall is—in the new state—less by at least 15% of the maximum distance R of the points of the third part of the bottom wall as measured with respect to the tread surface in the new state.

5. The tread according to any one of claim 1, wherein the first part of the bottom wall is formed of a circular arc having a small radius of curvature, namely a radius at least equal to 5% of the width W of the groove and at most 30% of same width W.

6. The tread according to claim 1, wherein the second part extending the first part of the bottom wall is planar or near-planar, i.e. has curvatures that are very slight.

7. The tread according to claim 1, wherein the distance separating the third part of the bottom wall from the bottom of the groove is at most equal to 10% of the depth P of the groove.

8. The thread according to claim 1, wherein a housing is formed transversely on the bottom of the groove so as to allow the bottom wall of a blade to become at least partially lodged therein in order to increase the extent to which the cross section of the said groove is closed by the said blade.

9. A passenger vehicle tire provided with a tread according to claim 1.
